(19) United States
(12) Patent Application Publication
(10) Pub. No.: US 2026/0116748 A1
(43) Pub. Date: Apr. 30, 2026

(54) Method and system for producing hydrogen from ammonia cracking

(71) Applicant: TOPSOE A/S, Kgs. Lyngby (DK)

(72) Inventors: Pat A. HAN, Smørum (DK); Emil Andreas TJÄRNEHOV, Limhamn (SE); Søren Grønborg ESKESEN, Espergærde (DK)

(73) Assignee: TOPSOE A/S, Kgs. Lyngby (DK)

(21) Appl. No.: 18/280,903

(22) PCT Filed: Mar. 10, 2022
(86) PCT No.: PCT/EP2022/056166

§ 371 Date: Sep. 7, 2023

(30) Foreign Application Priority Data
Mar. 11, 2021 (EP) 21162069.5

(51) Int. Cl. C01B 3/047

(52) U.S. Cl. CPC C01B 3/047; C01B 2203/0272; C01B 2203/042; C01B 2203/0465; C01B 2203/085; C01B 2203/0883

(57) ABSTRACT

Method and system for producing a hydrogen product from ammonia, comprising: optionally at least one pre-cracking reactor, such as an adiabatic pre-cracking reactor, arranged to receive an ammonia feed stream, thereby producing a partly converted ammonia feed stream comprising ammonia, hydrogen and nitrogen; an ammonia cracking reactor such as an electrically heated reactor. The reactor is arranged to receive the partly converted ammonia feed stream or the ammonia feed stream for producing an effluent gas stream comprising hydrogen and nitrogen and optionally also unconverted ammonia; and a hydrogen recovery unit arranged to receive the effluent gas stream for producing the hydrogen product and an off-gas stream comprising hydrogen, nitrogen and optionally unconverted ammonia.

The present invention relates to a method and system for cracking ammonia for producing hydrogen. Embodiments include optionally passing an ammonia feed to at least one adiabatic pre-cracking reactor, subsequent cracking in an ammonia cracking reactor and hydrogen purification in a hydrogen recovery unit. The present invention is relevant for all technical fields using ammonia as a source of energy and/or for production of hydrogen. In particular, the present invention is relevant when ammonia is the major or only energy source, which is important in the green transition using ammonia as an energy carrier.

This scheme having ammonia as the major or only energy source is important in the green transition using ammonia as an energy carrier

Liquid ammonia is an important source to produce hydrogen because it is an important energy carrier, for instance in regions with few or no fuel sources. The advantage of ammonia as energy carrier is that liquid ammonia is easier to transport and to store than for instance natural gas or hydrogen gas. Additionally, storing energy in ammonia is less expensive than e.g. in hydrogen or batteries.

When using ammonia as an energy carrier or hydrogen carrier, ammonia can be utilized directly in combustion engines/gas turbines or fuel cells and/or it can be cracked/decomposed into hydrogen and nitrogen. The decomposed ammonia can be fed to a gas turbine or hydrogen can be recovered for fuel cells or other use.

U.S. Pat. No. 4,704,267 discloses a method where ammonia is vaporized and subsequently dissociated into is constituents. The resulting dissociated gas stream is passed to an adiabatic metal hydride purification unit to absorb hydrogen present in the stream. The adsorbed hydrogen is then recovered as high purity product.

Applicant's WO2019038251 A1 discloses a process comprising non-catalytic partial oxidation of ammonia with an oxygen containing gas to form a process gas containing nitrogen, water, amounts of nitrogen oxides and residual amounts of ammonia; cracking of at least a part of the residual amounts of ammonia to hydrogen and nitrogen in the process gas by contact with a nickel containing catalyst and simultaneously reducing the amounts of nitrogen oxides to nitrogen and water by reaction with a part of the hydrogen formed during cracking of the process gas by contact of the process gas with the nickel containing catalyst; and withdrawing the hydrogen and nitrogen containing product gas.

US 20160340182 A1 discloses ammonia cracking by the use of a metal-supporting catalyst suitable for ammonia decomposition, and where the hydrogen generated is used, after purification, in fuel cells. The ammonia decomposition into nitrogen and hydrogen is conducted at 350-800° C., preferably in the range 400-600° C. for a Ru catalyst, and 500-750C for Ni or Co catalyst.

WO 20111107279 A1 discloses hydrogen production from ammonia for feeding a fuel cell. An apparatus is provided for generating hydrogen from ammonia stored in solid materials such as metal amine salts, and integration thereof into low temperature fuel cells.

US 2009274591 A1 discloses also hydrogen production in combination with a fuel cell. A compact apparatus is provided for the decomposition of liquid ammonia into hydrogen and nitrogen, in which the hydrogen is supplied to an alkaline fuel cell. The apparatus has three reactors placed in cascade, the first two reactors carrying out a thermo-catalytic resolution, and the third reactor being a microwave resonator. Hydrogen adapted to supply alkaline fuel cells is obtained after crossing a scrubber. The fuel cell is provided for the production of car drive.

The above prior art is at least silent on the cooling of effluent gas from ammonia cracking with an ammonia feed stream prior to recovering the hydrogen therefrom.

It is also known to use fire heated reactors comprising catalyst-filled tubes for dissociating ammonia into hydrogen and nitrogen. The firing and thus heating is normally conducted by using natural gas so all the hydrogen in the ammonia will go to the effluent gas stream and the waste heat is recovered for steam production, which is then used to drive rotating machines in those plants.

It would be desirable to provide a method (process) and system (plant) for producing a hydrogen product from ammonia with reduced or no production of steam.

Accordingly, in a first aspect, the invention is a method for producing a hydrogen product from ammonia, comprising the steps of:
i) providing an ammonia feed stream;
ii) passing the ammonia feed stream to at least one ammonia pre-cracking reactor for producing a partly converted ammonia feed stream comprising ammonia, hydrogen and nitrogen;
iii) passing the partly converted ammonia feed stream to an ammonia cracking reactor for producing an effluent gas stream comprising hydrogen and nitrogen and optionally also unconverted ammonia;
iv) passing the effluent gas stream to a hydrogen recovery unit for producing said hydrogen product and an off-gas stream comprising hydrogen, nitrogen and optionally unconverted ammonia,
wherein step iv) comprises the cooling of the effluent gas stream by heat exchange with the ammonia feed stream prior to passing the effluent gas stream to the hydrogen recovery unit.

For the purposes of the present application, the term “first aspect” or “first aspect of the invention” means embodiments related to the method (process). The term “second aspect” or “second aspect of the invention” means embodiments related to the system (process plant i.e. plant).

It would be understood, that a given step may comprise one or more sub-steps. It would also be understood, that a given step is conducted in a corresponding unit or combination of units.

As used herein, the term “ammonia” shall be understood broadly and includes the ammonia feed stream. The term “ammonia feed stream” is to be understood as a “gaseous ammonia feed stream”, and which is for instance derived from liquid ammonia such as liquid ammonia imported from storage as it also will become apparent from the below embodiments. It would also be understood, that the term partly converted ammonia feed stream is also a gas and thus the term “partly converted ammonia feed stream” has the same meaning as “partly converted gaseous ammonia feed stream”.

The provision of heat integration for electricity production purposes based on ammonia as the major or only energy source is different from the case of heat integration for hydrogen production purposes based on ammonia as the major or only energy source. For the former case heat can be recovered for steam production for additional electricity output, whereas for the latter case, which the present invention addresses, only hydrogen generation counts so waste heat should be limited i.e. minimized. The present invention enables limiting the waste heat for production of steam, where it is considered of low value or of no use. Having ammonia as the major or only energy source is important in the green transition using ammonia as an energy carrier.

In an embodiment according to the first aspect of the invention, the at least one ammonia pre-cracking reactor is an adiabatic ammonia pre-cracking reactor comprising a catalytic fixed bed and having a decrease in temperature from the inlet to the outlet of the reactor, e.g. of 50-200° C.

Adiabatic reactors are well-known in the art and thus also have a well-known meaning in the art, namely a reactor, typically a reactor comprising a fixed catalyst bed, where there is an increase or decrease in temperature from the inlet to the outlet of the reactor. For an exothermic reaction there is an increase in the temperature, while for an endothermic reaction there is a decrease in the temperature.

For the purposes of the present application, the term “adiabatic ammonia pre-cracking reactor comprising a catalytic fixed bed” means a reactor where is a decrease in temperature from the inlet to the outlet of the reactor. For instance, the reactor comprises a fixed bed of catalyst suitable for ammonia cracking and the temperature decrease is of 50-200° C. or 100-200° C., such as 150° C. For instance, the inlet temperature is 550° C. and the outlet temperature 400° C.

In the at least one adiabatic ammonia pre-cracking reactor, the catalytic fixed bed is provided with a catalyst active in ammonia cracking to partially crack the ammonia feed using e.g. waste heat from the convection section of the ammonia cracking reactor. The use of the waste heat reduces the duty of the ammonia cracking reactor and hence hydrocarbon feed gas, e.g. natural gas, consumption, thereby also reducing energy consumption. The provision of the at least one adiabatic ammonia pre-cracking reactor enables also reducing the size of the ammonia cracking reactor. Other benefits are recited below.

In an embodiment according to the first aspect of the invention, the ammonia cracking reactor is a fire heated reactor comprising one or more catalyst-filled tubes.

The catalytic fixed-bed and catalyst-filled tubes contain a catalyst active in ammonia cracking. The catalyst is suitably an ammonia synthesis catalyst.

In an embodiment according to the first aspect of the invention, the at least one pre-cracking reactor and/or the ammonia cracking reactor operate in the temperature range 300-700° C. and with an ammonia synthesis catalyst, such as any of: Fe, Co, Ru or Ni based catalyst, preferably a Fe-based catalyst.

Hence, suitably, the catalyst is a Fe-based catalyst, i.e. a monometallic catalyst system having Fe as the metal. Suitably the catalyst is promoted with any of K₂O, CaO, SiO₂, Al₂O₃. The Fe-based catalyst may be supported such as Fe/Al₂O₃, or unsupported such as Fe fused with any of K₂O, CaO, Al₂O₃. The Fe-based catalyst provides a much more inexpedient solution due to the lower price of iron.

The selection of the catalyst is independent of the type of ammonia cracking reactor used.

In an embodiment according to the first aspect of the invention, the at least one adiabatic pre-cracking reactor operates in the temperature rage 350-600° C., for instance 350-500° C., 350-550° C. or 400-550° C. For instance, the inlet temperature may be 500 or 550° C., and the outlet temperature may be 400° C.

The pre-cracking step (step ii) enables to convert part of the ammonia as an initial step in the process and protects the catalyst in the downstream ammonia cracking reactor. Protection and/or prolonged lifetime of inexpensive catalysts, in particular Fe-based catalysts, is achieved due to hydrogen presence, in particular because ammonia may react with the Fe-based catalyst and form iron nitrides, Fe₂N or Fe₄N. This reaction is particularly pronounced at higher temperature, such as above 500° C. or 600° C. and in pure ammonia.

Iron nitride formation leads to physical decomposition of the catalyst, which could further induce catalyst deactivation and increased pressure drop over the catalyst bed, thereby leading to increased process cost. Hydrogen in the partly converted ammonia feed stream therefore hinders the iron nitride formation. These considerations are also valid for the reactor material, by the presence of hydrogen enabling protection of the materials, e.g. catalyst filled tubes, towards nitridation.

In an embodiment according to the first aspect of the invention, step ii) comprises preheating the ammonia feed stream prior to passing the ammonia feed stream to the at least one adiabatic ammonia pre-cracking reactor, preferably by passing the ammonia feed stream to a plurality of pre-cracking reactors, for instance two adiabatic pre-cracking reactors.

In the ammonia cracking process, either in a pre-cracking reactor or a subsequent ammonia cracking reactor, gaseous ammonia is dissociated into a mixture of hydrogen and nitrogen gases in the reversible reaction: 2 NH₃(g)⇄N₂(g)+3 H₂(g) (1). Reaction (1) is endothermic, requiring heat for maintaining the ammonia cracking reaction ongoing. and hence the temperature will decrease across the adiabatic pre-cracking reactor, herein also referred as adiabatic reactor, as the reaction is shifted to the right. The ammonia feed stream is heated to e.g. superheated conditions, for instance up to an inlet temperature of about 500-600° C., such as about 550° C. and sent to a series of adiabatic reactors with heating in between the reactors, i.e. inter-stage heating. Since the process is endothermic, a temperature decrease of about 100° C. or more occurs in the adiabatic reactor, hence the outlet temperature can for instance be about 400° C. The higher the inlet temperature e.g. 500-600° C., the higher the ammonia conversion and thus the hydrogen being generated.

The plurality of preheating steps with adiabatic reactors, for instance when using two adiabatic reactors arranged in series with inter-stage heating, allows for a minimum of firing/heating for ammonia cracking, thus resulting in a minimum of waste heat so there is no waste heat available for steam production. Furthermore, reduction in size of the downstream ammonia cracking reactors, for instance a fire heater reactor is achieved. Overall lower costs result since: adiabatic reactors are less costly than the fire heated ammonia cracking reactor, which is reduced in size; furthermore, there is no need for providing steam-generation equipment.

The use of at least one pre-cracking reactor, such as adiabatic reactors as recited above, conveys also the advantage that the operating temperature in the pre-cracking reactors be gradually increased, thereby gradually generating more and more hydrogen which inhibits nitridation.

In traditional ammonia cracking, the dissociation of ammonia according to reaction (1) is normally conducted by directly i.e. with no upstream pre-cracking, subjecting an ammonia feed stream at high temperatures of e.g. 850-950° C. and in the presence of nickel as catalyst in a fire heated reactor. Due to the higher temperatures required, the lifetime of the catalyst is reduced due to the thermal sintering of the catalyst. The resulting gas mixture is composed of hydrogen and nitrogen in the proportion 3:1 (75% of H₂ and 25% of N₂) with very little amount (20-100 ppm) of residual undissociated ammonia with dew point −51° C. to −29° C. When performed under the conditions of the present invention, catalysts are preferably Fe-based and the process is performed at lower temperatures in the range 300-700° C., as recited above. Particularly for the fire heated reactor, this reactor is for instance operated at temperatures in the range 600-700° C., which increases conversion to hydrogen. The higher temperatures may in some instances still require the use of more expensive catalysts capable of operating at such temperatures, such as a nickel-based catalyst. For instance, the temperature of a preheated partly converted ammonia feed stream, corresponding to the inlet temperature of the fire heated reactor, is suitably about 600° C., such as 580 or 590° C., while the temperature of the effluent gas stream, corresponding to the outlet temperature of the fire heated reactor, is about 700° C. such as 710, 715, 720 or 725° C.

Accordingly, in a preferred embodiment according to the first aspect of the invention, the ammonia cracking reactor is a fire heated reactor comprising one or more catalyst-filled tubes. This reactor is the same as a tubular reformer i.e. conventional steam methane reformer (SMR), where the heat for catalytic dissociation of ammonia is transferred chiefly by radiation in a radiant furnace, and where now instead of using typical feed stream such as natural gas or pre-reformed natural gas, the feed stream is the partly converted ammonia feed stream.

In another embodiment according to the first aspect of the invention, the ammonia cracking reactor is a convection heated reactor, preferably comprising one or more bayonet tubes such as an HTCR reformer i.e. Topsøe bayonet reformer, where the heat for ammonia cracking is transferred by convection along with radiation. This type of reactor enables that the effluent gas stream from the reactor be of lower temperature than in for instance a fire heated reactor, for instance at about 550° C. in the convection reactor compared to about 700° C. in the fire heated reactor. Thereby it is possible to operate with more inexpensive catalysts, in particular Fe based catalysts.

In another embodiment according to the first aspect of the invention, the ammonia cracking reactor is an electrically heated reactor, where electrical resistance is used for generating the heat for catalytic dissociation of ammonia. This is for instance suitable where electricity is readily available, particularly when available from green source such as by power generated from solar or wind sources. This reactor can operate a high temperatures and pressures, for instance at 1000° C. or more, as well as pressures of 100 barg or higher, such as 500 barg or even higher, which can be relevant for certain downstream applications requiring hydrogen product being recovered or delivered at high pressures, such as at about 700 barg. Despite the high pressure, the higher temperature in the reactor enables also a lower ammonia slip in the effluent gas stream of the reactor. In addition, the electrically heated reactor provides for a much lower pressure drop and a much more compact solution, thus significantly reducing plot size in the plant.

In another embodiment according to the first aspect of the invention, the ammonia cracking reactor is an induction heated reactor, where a tube heat exchange reactor includes the use of an induction coil in order to generate an alternating magnetic field within at least a part of an inner tube comprising a bed of catalyst material susceptible for induction heating. This is for instance also suitable where electricity is readily available, particularly when available from green source such as by power generated from solar or wind sources.

Combination of these reactors is also envisaged.

For more information on these reactors, details are herein provided by direct reference to applicant's patents and/or literature. For instance, for tubular and autothermal (ATR) reforming an overview is presented in “Tubular reforming and autothermal reforming of natural gas-an overview of available processes”, Ib Dybkjær, Fuel Processing Technology 42 (1995) 85-107; and EP 0535505 for a description of HTCR. For a description of autothermal reforming (ATR) and/or SMR for large scale hydrogen production, see e.g. the article “Large-scale Hydrogen Production”, Jens R. Rostrup-Nielsen and Thomas Rostrup-Nielsen”, CATTECH 6, 150-159 (2002). For a description of electrically heated reactors, which is a more recent technology, reference is given to particularly to applicant's WO 2019/228798 A1 and co-pending patent application PCT/EP2020/076704 (WO 2021063795). For a description of the induction heated reactor, reference is given to applicant's WO 2017/186437 A1.

For instance, the electrically heated reactor is suitably a reactor system comprising: a supply of feed gas comprising ammonia, for instance the partly converted ammonia feed stream comprising ammonia, hydrogen and nitrogen; a structured catalyst arranged for catalysing the ammonia cracking reaction of said feed gas, said structured catalyst comprising a macroscopic structure of an electrically conductive material, said macroscopic structure supporting a ceramic coating, wherein said ceramic coating supports a catalytically active material; a pressure shell housing said structured catalyst, said pressure shell comprising an inlet for letting in said feed gas and an outlet for letting out a product gas i.e. the effluent gas from the reactor comprising hydrogen, nitrogen and optionally unconverted ammonia, wherein said inlet is positioned so that said feed gas enters said structured catalyst in a first end of said structured catalyst and said product gas exits said structured catalyst from a second end of said structured catalyst; a heat insulation layer between said structured catalyst and said pressure shell; at least two conductors electrically connected to said structured catalyst and to an electrical power supply placed outside said pressure shell, wherein said electrical power supply is dimensioned to heat at least part of said structured catalyst to a temperature of at least 300° C. by passing an electrical current through said macroscopic structure, wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors; an outlet for the product stream.

In an embodiment, said feed gas comprising ammonia is the ammonia feed stream. Hence, the ammonia feed stream is supplied (passed) to the electrically heated reactor without ammonia pre-cracking. In other words, step ii) may be omitted. Thereby, a simpler process and plant is provided. The ammonia feed stream may thus be a substantially pure stream of ammonia, for instance by having more than 99.5 vol. % ammonia.

Accordingly, the invention may also be recited as a method for producing a hydrogen product from ammonia, comprising the steps of:
i) providing an ammonia feed stream;
ii) optionally, passing the ammonia feed stream to at least one ammonia pre-cracking reactor for producing a partly converted ammonia feed stream comprising ammonia, hydrogen and nitrogen;
iii) passing the partly converted ammonia feed stream or the ammonia feed stream to an ammonia cracking reactor for producing an effluent gas stream comprising hydrogen and nitrogen and optionally also unconverted ammonia, wherein the ammonia cracking reactor is an electrically heated reactor;
iv) passing the effluent gas stream to a hydrogen recovery unit for producing said hydrogen product and an off-gas stream comprising hydrogen, nitrogen and optionally unconverted ammonia;
wherein step iv) comprises the cooling of the effluent gas stream by heat exchange with the ammonia feed stream prior to passing the effluent gas stream to the hydrogen recovery unit.

The absence of the pre-cracking step ii) is not confined to the use of an electrically heated reactor as the ammonia cracking reactor of step iii). For instance, the ammonia cracking reactor is suitably a fired heated reactor comprising one or more catalyst filled tubes.

In an embodiment according to the first aspect of the invention, the method further comprises:
v) passing the off-gas stream, i.e. off gas stream of step iv), to the fire heated reactor or convection heated reactor upon mixing it with an air stream i.e. combustion air, optionally also with a separate fuel stream, for generating heat required in the fire heated reactor or convection heated reactor.

The majority of the off-gas stream is nitrogen and contains also hydrogen and unconverted ammonia. For instance, when operating with a hydrogen recovery unit having one Pressure Swing Adsorption (PSA) unit, in the off-gas stream the nitrogen content is e.g. about 60% vol., hydrogen e.g. about 30% vol., an unconverted ammonia e.g. about 10% vol. The off-gas stream is hereby used as fuel in e.g. the fire heated reactor by mixing with a separate incoming stream of combustion air, preferably at different locations along the length of the fired reactor (fire heated reactor), more specifically along its wall and corresponding to the positions of burners arranged therein for generating a flame and thereby radiant heat required for the catalyst filled tubes. Hence, while normally the fuel used for the burners would be provided from an external source, typically in the form of natural gas, the use of such natural gas is now substantially reduced or omitted. A higher energy efficiency in the process is thereby achieved while at the same time enabling a lower carbon footprint of the process and plant. The fire heated reactor or convection heated reactor may be designed to operate on other fuel sources, i.e. to operate with the separate fuel stream such as natural gas, if necessary.

A separate fuel stream such as natural gas may be added where the off-gas stream is mainly rich in nitrogen, and thus of less value as fuel, for the instance where two PSA-units are utilized. More specifically, when operating with a hydrogen recovery unit having two or more PSA units, the off-gas stream becomes leaner in hydrogen and richer in nitrogen compared to when operating with one PSA unit. When operating with two PSA units, the off-gas stream may have about 10% vol. hydrogen, close to 90% vol. nitrogen and some unconverted ammonia e.g. about 5% vol. This off-gas is suitably used as fuel in the fire heated reactor or convection heated reactor by mixing with the combustion air, while a separate fuel stream such as natural gas is also added. When utilizing a convection heated reactor, the mixture of off-gas, combustion air and optional separate fuel stream e.g. natural gas, is burned, for instance in a combustion chamber at the bottom of the convection heated reactor, for generating a flame and thereby radiant heat which is required for heating flue gas and thereby also the heating of bayonet tubes comprising catalyst. Each bayonet tube is surrounded by another tube that guides the heated flue gas in the vicinity of the tube.

In an alternative embodiment according to the first aspect of the invention, the method further comprises:
v) passing the off-gas stream to a fired heater upon mixing it with an air stream, optionally also with a separate fuel stream, for preheating the ammonia feed gas stream, preferably where said ammonia cracking reactor is an electrically heated reactor or an induction heated reactor.

When in particular utilizing these ammonia cracking reactors, the heating is powered by electricity and thus there is no need to use the off-gas for burning as for the fire heated reactor and convection heated reactor. The off-gas stream is mixed with combustion air and optionally also a separate fuel stream such as natural gas, and then burned for generating the heat. The fired heater, which is well known in the art, provides thereby heat for preheating the ammonia feed gas stream prior to entering a pre-cracking adiabatic reactor, and/or prior to entering the ammonia cracking reactor.

Accordingly, in a particular embodiment, in said step v) the separate fuel stream may be natural gas.

More advantageously, in a particular embodiment, the method comprises diverting a portion of said effluent gas stream and supplying it as at least a portion of said separate fuel stream. The portion of said effluent gas stream may for instance be withdrawn as part of the produced effluent gas stream from the ammonia cracking reactor i.e. the effluent gas stream exiting the ammonia cracking reactor, or as part of the cooled effluent gas stream entering the hydrogen recovery unit. The term “as at least a portion of said fuel stream” means that it may be provided alone as the separate fuel stream, or together with another fuel stream, such as hydrogen, in particular hydrogen produced in the process, or—if necessary—an external fuel source, for instance by supplying natural gas as supplementary fuel only.

Hence, in another particular embodiment, a hydrogen stream is provided as at least a portion of said separate fuel stream, suitably hydrogen produced in the method (process) or system (plant) of the invention.

In another embodiment, the method comprises diverting a portion of an ammonia stream, such as a portion of the ammonia feed stream, and supplying it as at least a portion of said separate fuel stream. Hence, an ammonia stream is provided as at least a portion of said separate fuel stream, suitably a portion of an ammonia gas stream produced in the method (process) or system (plant) of the invention), such as a portion of the ammonia feed stream.

Combinations of the above are also envisaged.

Thereby, the separate fuel stream comprises hydrogen, or a mixture of hydrogen and nitrogen, or ammonia. The provision hydrogen, from instance hydrogen produced in the method and system of the invention, enables a burning with a significantly reduced carbon foot print, as no carbon dioxide is emitted compared to when using a carbon-containing fuel such as natural gas as the fuel stream. The separate fuel stream may also comprise ammonia, which also is suitable for burning with no generation of carbon dioxide and thus enabling also a reduced carbon footprint.

In an embodiment according to the first aspect of the invention, step iii) further comprises generating a hot flue gas stream and recovering heat thereof by at least one of:
said preheating of the ammonia feed stream prior to passing the ammonia feed stream to the at least one adiabatic ammonia pre-cracking reactor;
preheating of the partly converted ammonia feed stream, i.e. the ammonia feed stream after passing to the at least one adiabatic ammonia pre-cracking reactor;
preheating of the off-gas stream; or
preheating of the air stream.

This enables achieving hydrogen production from ammonia cracking using waste heat in e.g. the fire heated ammonia cracking reactor for preheating one or more streams, including the ammonia feed stream to an adiabatic ammonia pre-cracking reactor, instead of producing steam, thereby also maximizing the yield of hydrogen and increasing process and plant efficiency. For the hydrogen business it is essential to have the maximum hydrogen output, thus any additional percent point in hydrogen yield and thereby efficiency significantly counts.

The hot flue gas stream travels through a convection section of the fire heated reactor, as is well known in the art of SMR technology. The combustion air stream is suitably preheated by heat exchange with the hot flue gas stream from e.g. 20° C. to 300-350° C., while the off-gas stream is preheated by heat exchange with the hot flue gas stream from e.g. 40° C. to 150-200° C. As a particular example, the combustion air stream is indirectly heat exchanged at a portion of the convection section where the temperature of the flue gas is about 200-400° C., while the off-gas stream is indirectly heat exchanged at a portion of the convection section where the temperature of the flue gas is 150-200° C.

By the invention, step iv) further comprises the cooling of the effluent gas stream by heat exchange with the ammonia feed stream prior to passing the effluent gas stream to the hydrogen recovery unit.

In a particular embodiment, the ammonia feed stream is derived, i.e. produced, from liquid ammonia such as liquid ammonia imported from storage, for instance liquid ammonia or liquid anhydrous ammonia, and which has been subjected to: optional water removal e.g. by electrolysis or distillation, evaporation e.g. in an ammonia evaporator, and optional pre-heating e.g. in a feed/effluent heat exchanger prior to said evaporation. It would be understood, that any of such steps of water removal, evaporation and pre-heating prior to said evaporation, may be part of the method according to the invention.

Thereby, further heat integration is achieved, as all important waste heat available is used. By way of example, for preheating and evaporation, as well as for subsequent preliminary preheating of the ammonia feed stream from e.g. about 90° C. to 300-350° C., the effluent gas stream is used as heat exchanging medium. For the further pre-heating of the ammonia feed stream to a temperature of about 500° C., the flue gas of e.g. the fire heated reactor is used as heat exchanging medium. When operating with e.g. an electrically heated reactor, the pre-heating of the ammonia feed is suitably provided by a fired heater, as described farther above. Particularly when operating with a plurality of pre-cracking reactors, more particularly when operating with two or more adiabatic ammonia cracking reactors, as also recited farther above, there is no available waste heat which is used for production of steam, which is highly advantageous where steam is considered as being of low value or of no use.

Suitably, the effluent gas stream from the ammonia cracking reactor, apart from providing the above mentioned preliminary preheating of the ammonia feed stream in a first feed/effluent heat exchanger, is also used to drive an ammonia evaporator for providing the evaporation of ammonia into a gaseous stream suitable for the downstream ammonia cracking, i.e. as said ammonia feed stream, as well as optionally also for preheating liquid ammonia being pumped from storage in a second feed/effluent heat exchanger.

It would be understood, that the term “liquid ammonia imported from storage” has the same meaning as “liquid ammonia being pumped from storage”.

After delivering heat in said second feed/effluent heat exchanger, the effluent gas stream may be further cooled in a heat exchanger using water as cooling medium i.e. a water cooler, thereby finally bringing the temperature of the effluent gas stream from for instance about 700° C. or 550° C. at the outlet of, respectively, the fire heated reactor or convection heated reactor, to about 50° C. before entering the hydrogen recovery unit.

As described above, ammonia synthesis catalysts can be used for decomposition or cracking of ammonia. However, water or other oxygen containing compounds may poison the ammonia synthesis catalyst. Since water is the main compound in traded liquid ammonia, the poisoning of these synthesis catalysts is considered to be a problem affecting the catalyst performance and therefore influencing the effectiveness and efficiency of the process. This is at least one of the reasons why other, more expensive, catalysts are traditionally used in ammonia cracking. Hence, while it is possible to operate with an ammonia feed stream having minor amounts of water by using more expensive catalysts, such as Ru based catalysts, it would be desirable to be able to operate the process and process plant with less expensive ammonia cracking catalysts such as Fe based catalysts.

Due to transport requirements, traded liquid ammonia normally contains some water, even when it is called anhydrous. For instance, by the present invention, the liquid ammonia being pumped from storage may have a water content of about 0.2 mole % or 0.5 mole %. While this water may be withdrawn as a water purge stream in the ammonia evaporator, an optional water removal is suitably provided, such as electrolysis or distillation.

In a particular embodiment, said water removal is conducted, i.e. performed, by subjecting the liquid ammonia imported from storage to electrolysis in an alkaline or polymer electrolyte membrane (PEM) electrolysis unit, such as a high pressure alkaline or PEM electrolysis unit, thereby generating said ammonia feed stream, as well as an oxygen product and a hydrogen product. By high pressure alkaline or PEM electrolysis unit is meant a unit capable of operating at elevated pressure, for instance at 10 bar or higher.

Electrolysis upstream the ammonia evaporator, in particular electrolysis of the liquid ammonia imported from storage, e.g. in an alkaline or PEM electrolysis unit (herein also referred as alkaline/PEM electrolysis), is preferred where electricity is readily available, particularly when available from green sources such as instances where power is generated from solar or wind sources. Alternatively, power may be generated by a thermonuclear source, i.e. by nuclear power. The water in the liquid ammonia is converted by electrolysis to oxygen and hydrogen product.

In a particular embodiment, at least a portion of the hydrogen product from electrolysis is combined with the ammonia feed stream in the at least one ammonia pre-cracking reactor. Thereby, not only more hydrogen product is produced, but also a further source of hydrogen is provided for inhibiting undesired nitridation, since the hydrogen is carried in the process and ends up in the hydrogen product. The portion of the hydrogen product from the electrolysis which is not combined with the ammonia feed gas, is suitably incorporated into the hydrogen product, for instance by mixing with the hydrogen product from the hydrogen recovery unit. In another embodiment, at least a portion of the hydrogen product from electrolysis is supplied as said separate fuel stream, i.e. for the fire heated ammonia cracking reactor or the fired heater.

In a particular embodiment, step iv) further comprises recovering unconverted ammonia in the effluent gas stream by distillation in an ammonia recovery distillation column (also referred as distillation column) after said cooling of the effluent gas stream by heat exchange with the ammonia feed stream, and wherein after said cooling and prior to the distillation, the thus cooled effluent gas stream is supplied to an effluent gas separator, such as an effluent gas scrubbing unit using water as scrubbing medium, for generating an overhead stream comprising nitrogen and hydrogen, and a bottom liquid stream comprising the unconverted ammonia.

At least a portion of the overhead stream from the effluent gas separator is passed to the hydrogen recovery unit. The other portion is withdrawn as a nitrogen stream. Suitably, the entire portion of the overhead stream from the effluent gas separator is passed to the hydrogen recovery unit. The bottom liquid stream comprising the unconverted ammonia, having and ammonia content of e.g. about 15 mole %, with the rest being predominantly water, is then preheated in for instance a heat exchanger using the bottoms stream of the distillation column, which is predominantly water, as heat exchanging medium, and then fed to said distillation column. Optionally, prior to such preheating, a portion of the bottom liquid stream from the effluent gas separator is combined with cooled effluent gas being supplied to the effluent gas separator.

Suitably, said bottoms stream of the distillation water, which is predominantly water, optionally together with make-up water, is used as the scrubbing medium in the effluent gas scrubbing unit.

In a particular embodiment, the ammonia recovery distillation column (distillation column) is provided with an ammonia recovery reboiler (reboiler) and the effluent gas from the ammonia cracking reactor is cooled down in said reboiler, suitably prior to further cooling by providing said effluent gas as heat exchanging medium for said evaporation and/or said pre-heating of the ammonia feed stream which is derived from liquid ammonia such as liquid ammonia imported from storage. Thereafter, the thus cooled effluent gas, optionally after being combined with said a portion of the bottom liquid stream from the effluent gas separator, may be further cooled in an air cooler or water cooler, and supplied to the effluent gas separator.

In a particular embodiment, from the overhead stream of the distillation column, an ammonia rich stream i.e. having 99 mole % or more ammonia, is derived and combined with the liquid ammonia imported from storage. The ammonia rich stream is preferably a portion of a reflux stream to the distillation column. In another particular embodiment, after combining the ammonia rich stream from the overhead stream of the distillation column with the liquid ammonia imported from storage, the combined stream after being pre-heated and evaporated (in an ammonia evaporator), is supplied as the ammonia feed stream to the ammonia cracking reactor.

In another particular embodiment, said water removal is conducted by subjecting the ammonia feed gas stream from the evaporation step, i.e. after evaporating the ammonia feed gas in an ammonia evaporator, to distillation in said ammonia recovery distillation column, thereby generating said ammonia feed stream. The ammonia feed stream is then withdrawn as part of the overhead stream of the distillation column and is water-free, thereby enabling the use of inexpensive catalyst in the ammonia pre-cracking reactor(s) and/or the ammonia cracking reactor.

The bottom liquid from the effluent gas scrubbing unit is directed to said distillation column alongside the ammonia originating from the storage which has been preheated and/or evaporated. Thereby, the distillation column serves two purposes: a) limiting the amount of water going to the catalyst in the ammonia cracking reactor, optionally also in the ammonia pre-cracking unit, as water will reduce the catalyst activity, and b) recovering ammonia from the effluent gas separator e.g. effluent gas scrubbing unit.

In another particular embodiment, said pre-heating prior to evaporation of the ammonia feed stream which is derived from liquid ammonia such as liquid ammonia imported from storage, comprises heat exchanging, i.e. in an ammonia feed preheater, with an overhead gas stream withdrawn from the ammonia recovery distillation column.

Hence, a portion of the overhead gas stream withdrawn from the ammonia recovery distillation column is supplied, i.e. passed, as the ammonia feed stream to an ammonia pre-cracking reactor or to the ammonia cracking reactor, the other portion of the overhead gas stream is withdrawn as part of the reflux system of the distillation column. The cold liquid ammonia stream from storage, typically at −33° C., is thereby used to condense overhead gas in the reflux system of the distillation column, thereby obviating the use of other cooling types normally applied in a reflux system, for instance water cooling or air cooling, and thereby also preheating the ammonia feed stream itself.

In another particular embodiment, a light overhead gas stream comprising hydrogen and ammonia is withdrawn from the ammonia recovery distillation column, suitably from said overhead gas stream, and supplied to said effluent gas separator.

The reflux system of the distillation column comprises one or more heat exchangers for cooling the overhead gas stream withdrawn from the ammonia recovery distillation column, an ammonia recovery separator for producing a bottom reflux stream and the light gas overhead gas stream, and an ammonia recovery flux pump (reflux pump) for supplying at least a portion of said bottom reflux stream to the ammonia recovery distillation column. Suitably, the one or more heat exchangers do not include an air cooler, for instance the one or more heat exchangers consist of said ammonia feed preheater and optionally also a water cooler suitably arranged in parallel with said ammonia feed preheater.

From the distillation column, the portion of the overhead gas stream which is withdrawn in the reflux system is cooled in e.g. said ammonia feed preheater and passed to the ammonia recovery separator, thereby generating the light overhead gas stream comprising hydrogen and ammonia, e.g. about 40 mole % hydrogen, about 40 mole % ammonia and about 10 mole % nitrogen, and a reflux stream to the distillation column which is ammonia-rich i.e. having 99 mole % or more ammonia. The light overhead gas stream comprising hydrogen and ammonia is specifically withdrawn as the overhead fraction of said ammonia recovery separator, and then reused by supplying it to the effluent gas scrubbing unit, for instance by feeding it at the bottom of the effluent gas separator. Thereby, valuable hydrogen is subsequently provided to the hydrogen recovery unit, and the efficiency of the process (method) and plant (system) is increased.

In an embodiment according to the first aspect of the invention, the hydrogen recovery unit comprises at least one Pressure Swing Adsorption (PSA) unit for thereby producing said hydrogen product and said off-gas stream. Hence, hydrogen purification of the effluent gas stream from the ammonia cracking reactor, e.g. fire heated reactor or electrically heated reactor, is achieved by bringing in a PSA unit the hydrogen concentration from e.g. about 70% vol. in the effluent gas stream to above 99.9% vol. in the hydrogen product. From the PSA unit, the off-gas stream used as fuel in e.g. the fire heated reactor or convection heated reactor, as well as fuel in a fired heater for preheating of the ammonia feed stream when operating with e.g. an electrically heated reactor, is withdrawn. This off-gas stream contains for instance about 30% vol. H₂, 60% vol. N₂ and 10% NH₃ and some traces of H₂O.

In a particular embodiment, the hydrogen recovery unit comprises a first and second PSA unit for producing said hydrogen product, the method further comprising withdrawing and compressing a first off-gas stream from the first PSA unit and passing it to the second PSA unit for thereby producing said off-gas stream. The provision of e.g. two PSA units in series conveys also the advantage of increasing the hydrogen yield and recovering a hydrogen product at high pressure in the first PSA unit. The off-gas stream becomes however lean in hydrogen and ammonia, for instance by containing 8% vol. hydrogen and 92% vol. nitrogen, thus making it less feasible as fuel in the process.

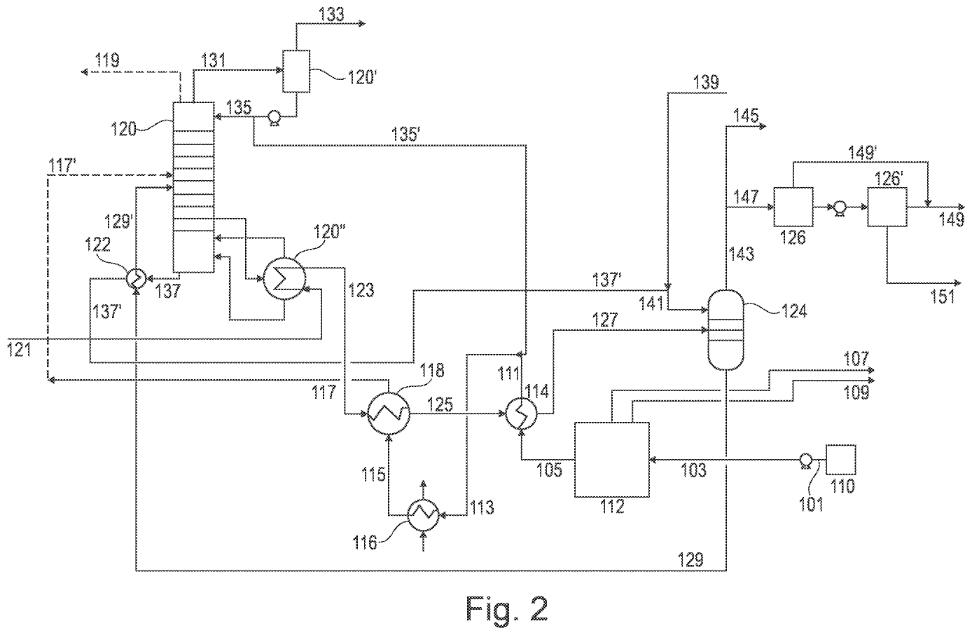

This embodiment enables also saving energy in terms of hydrogen product compression that would otherwise be required for downstream applications where the necessary pressure can be high, such as 700 barg. The first PSA unit operates at higher pressure than the second PSA unit; for instance, the first PSA unit may operate at about 100 barg while the second PSA unit may operate at more normal pressures, such as 30 barg. By way of example, about 80% of the hydrogen product comes from the first PSA unit at 100 barg (see e.g. stream 149′ FIG. 2), which thus is highly suitable for downstream applications using hydrogen at higher pressure as described above.

In another particular embodiment, the hydrogen recovery unit comprises a membrane unit and a PSA unit, more particularly a first membrane unit and subsequently, i.e. downstream, a PSA unit. Thereby, the need of a compression stage in between consecutive PSA units is avoided. The attendant capital and operating expenses related to compression are thus saved and both hydrogen product streams, i.e. from the membrane unit and the PSA unit, are recovered at the same pressure, e.g. about 30 barg, as normally used in hydrogen plants. Furthermore, membrane units are less costly than PSA units for same capacity, as is well known in the art of ammonia technology.

The invention, as recited above, envisages also a method in which there is no ammonia pre-cracking. Accordingly, now more specifically, the invention provides a method for producing a hydrogen product from ammonia, comprising the steps of:
providing an ammonia feed stream;
passing the ammonia feed stream to an ammonia cracking reactor for producing an effluent gas stream comprising hydrogen and nitrogen and optionally also unconverted ammonia;
passing the effluent gas stream to a hydrogen recovery unit for producing said hydrogen product and an off-gas stream comprising hydrogen, nitrogen and optionally unconverted ammonia; the step further comprising the cooling of the effluent gas stream by heat exchange with the ammonia feed stream prior to passing the effluent gas stream to the hydrogen recovery unit;
   and wherein prior to said step of passing the ammonia feed stream to the ammonia cracking reactor, the method is absent of a step of passing the ammonia feed stream to an ammonia pre-cracking reactor, i.e. at least one ammonia pre-cracking reactor, for producing a partly converted ammonia feed stream comprising ammonia, hydrogen and nitrogen.

A simpler process and plant layout is thereby obtained. Reduction in attendant capital and operating expenses is thereby also achieved.

It would be understood, that any of the recited embodiments may be combined with this embodiment in which there is no pre-cracking.

In a second aspect, the invention provides also a system, i.e. plant, for producing a hydrogen product from ammonia, comprising:
at least one pre-cracking reactor, such as an adiabatic pre-cracking reactor, arranged to receive an ammonia feed stream, said at least one pre-cracking reactor preferably having arranged therein a catalytic fixed-bed for producing a partly converted ammonia feed stream comprising ammonia, hydrogen and nitrogen;
an ammonia cracking reactor arranged to receive the partly converted ammonia feed stream for producing an effluent gas stream comprising hydrogen and nitrogen and optionally also unconverted ammonia;
a hydrogen recovery unit arranged to receive the effluent gas stream for producing the hydrogen product and an off-gas stream comprising hydrogen, nitrogen and optionally unconverted ammonia;
   wherein the system further comprises at least one heat exchanger adapted upstream the hydrogen recovery unit for cooling said effluent gas stream by heat exchange with the ammonia feed stream.

Suitably also, the system is absent of a pre-cracking reactor.

Accordingly, there is also provided a system for producing a hydrogen product from ammonia, comprising:
an ammonia cracking reactor arranged to receive an ammonia feed stream for producing an effluent gas stream comprising hydrogen and nitrogen and optionally also unconverted ammonia;
a hydrogen recovery unit, arranged to receive the effluent gas stream for producing the hydrogen product and an off-gas stream comprising hydrogen, nitrogen and optionally unconverted ammonia;
   wherein the system further comprises at least one heat exchanger adapted upstream the hydrogen recovery unit for cooling said effluent gas stream by heat exchange with the ammonia feed stream;
   and wherein the system is absent of a pre-cracking reactor, i.e. at least one pre-cracking reactor, upstream said ammonia cracking reactor.

Said pre-cracking reactor is otherwise arranged to receive an ammonia feed stream for producing a partly converted ammonia feed stream comprising ammonia, hydrogen and nitrogen.

A simpler process and plant layout is thereby obtained. Reduction in attendant capital and operating expenses is thereby also achieved.

In an embodiment, the ammonia cracking reactor is: a fire heated reactor comprising one or more catalyst-filled tubes, a convection heated reactor, an electrically heated reactor, an induction heated reactor, or combinations thereof.

In an embodiment, the system comprises an ammonia recovery distillation column (distillation column) arranged downstream said ammonia cracking reactor and upstream said hydrogen recovery unit, said ammonia recovery distillation column comprising a reboiler comprising an inlet to receive said effluent gas stream and an outlet for exiting a cooled the effluent gas stream.

In an embodiment, said at least one heat exchanger adapted upstream the hydrogen recovery unit for cooling said effluent gas stream by heat exchange with the ammonia feed stream, is an ammonia evaporator comprising an inlet to receive an ammonia feed stream, an inlet for receiving said cooled effluent gas stream from said reboiler, and an outlet for exiting an ammonia feed gas stream, the system further comprising a conduit such as a pipe for supplying said ammonia feed gas stream to said ammonia recovery distillation column.

Hence, as also described in connection with the first aspect of the invention, commercially available liquid ammonia containing traces of water, e.g. 0.2-0.5 mole % water, is imported from storage, pumped to operational pressure, sent to the ammonia evaporator further on to the distillation column for obtaining essentially water-free ammonia. This water-free ammonia represents the ammonia feed stream which is then supplied to an ammonia cracking reactor. In an embodiment, the ammonia feed stream is heated to superheated conditions in the convection section of a fired heated reactor comprising one or more catalyst filled tubes. The gas is on the catalyst side and fuel and combustion air is fired in a number of burners along the length of the tubes. The firing along the tubes promotes conversion of ammonia into hydrogen and nitrogen by keeping the temperature high enough. In another embodiment, ammonia feed stream is supplied to an electrically heated reactor. In the ammonia cracking reactor, the reaction of ammonia cracking takes place converting ammonia into hydrogen and nitrogen. The ammonia cracking reactor can be designed to produce an effluent gas with a low amount of unconverted ammonia.

The effluent gas from the catalyst side of the ammonia cracking reactor is suitably cooled down in the reboiler of said distillation column and said evaporator. Thereafter the thus cooled effluent gas, possibly after further cooling in an air cooler or water cooler, is sent to the effluent gas separator, e.g. effluent gas scrubbing unit, using water as scrubbing medium, for generating an overhead gas stream comprising nitrogen and hydrogen essentially free of ammonia, and a bottom liquid stream comprising the unconverted ammonia and water.

Said overhead gas stream is sent to the hydrogen recovery unit where separation into hydrogen product gas, for instance above 99% hydrogen and traces of nitrogen, and the off-gas takes place. The off-gas is suitably used as fuel in a fire heated ammonia cracking reactor, optionally along with other gaseous fuel source(s), such as natural gas.

The bottom liquid from the scrubbing unit is sent to said distillation column alongside the evaporated ammonia originating from the storage. Thereby, the distillation column enables limiting the amount of water going to the catalyst of the ammonia cracking reactor, as water will reduce the catalyst activity, and recovering ammonia from the scrubbing unit.

A light overhead gas from the reflux system of the distillation column primarily consisting of hydrogen and ammonia, secondly of nitrogen, is reused by sending it to the scrubbing unit. Thereby, valuable hydrogen is sent to the hydrogen recovery unit, and the efficiency of the system is increased.

The cold liquid ammonia stream from storage is used to condense overhead gas in said reflux system, thereby obviating the use of other cooling types, such as water cooling or air cooling, and preheating the ammonia feed stream itself.

In an embodiment, the hydrogen recovery unit comprises two individual hydrogen recovery units, possibly of pressure-swing-absorption (PSA) type and/or membrane types, with suitable compression in between the units where applicable, for obtaining the required purity of the hydrogen product.

Sensible heat in the flue gas of a fired heated reactor is primarily used to superheat ammonia prior to entering the catalyst filled tubes arranged therein. The heat in the flue gas is suitably also used to preheat combustion air and/or fuel such as natural gas. This limits the use of the fuel, e.g. natural gas.

It would be understood that any of the embodiments and associated technical advantages according to the first aspect of the invention may be combined with the second aspect of the invention, and vice versa.

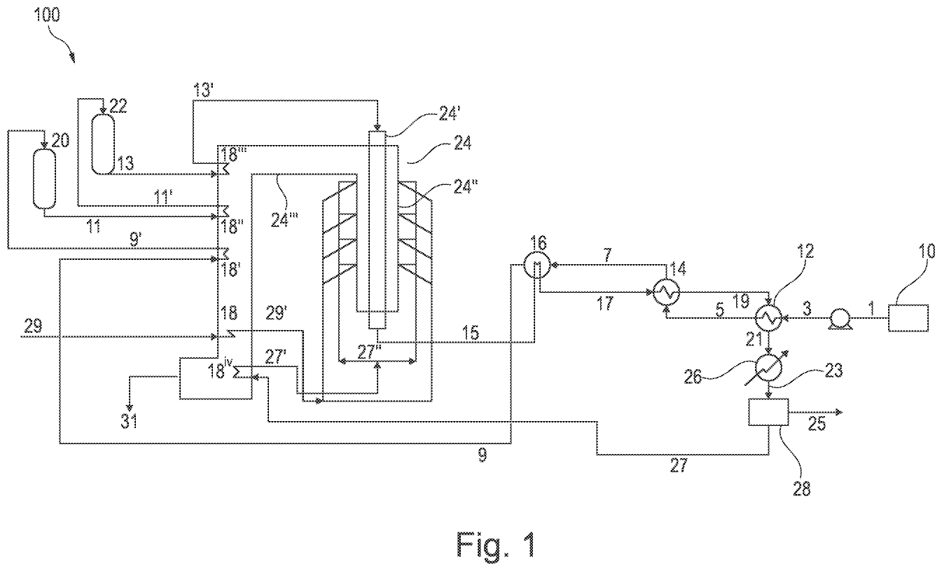

FIG. 1 shows a schematic layout of the process and plant according to an embodiment of the present invention including ammonia pre-cracking, ammonia cracking, effluent gas stream cooling and thereby preparation of the ammonia feed gas stream and hydrogen recovery.

FIG. 2 shows another schematic layout of the process and plant according to an embodiment of the present invention including effluent gas stream cooling, ammonia recovery and preparation of the ammonia feed gas stream including water removal in a distillation column, as well as hydrogen recovery.

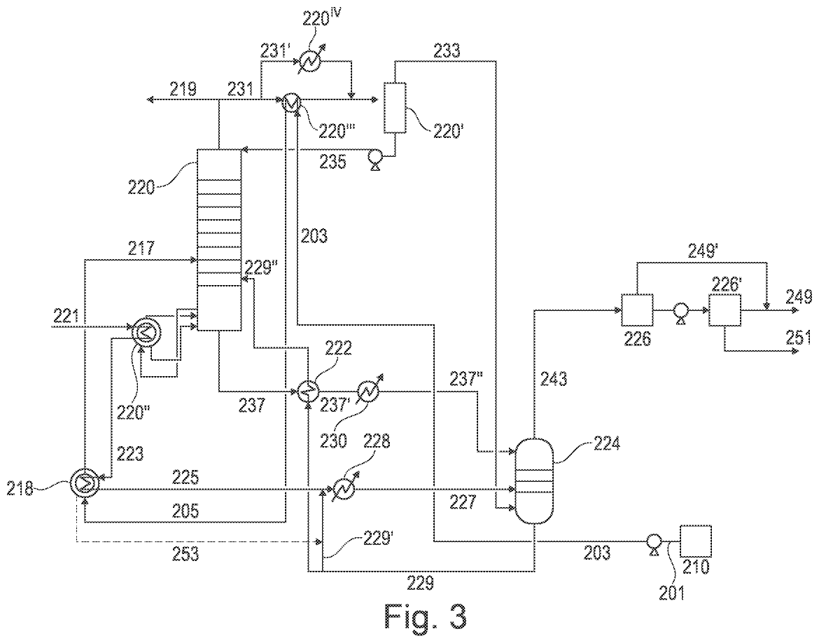

FIG. 3 shows yet another schematic layout of the process and plant according to an embodiment of the present invention including effluent gas stream cooling, ammonia recovery and preparation of the ammonia feed gas stream including water removal in a distillation column, as well as hydrogen recovery.

With reference to FIG. 1, the process and plant scheme 100, herein also referred as “scheme”, shows a storage 10 for liquid ammonia from which an ammonia feed stream is derived. The liquid ammonia 1 is pumped as liquid ammonia stream 3 to a second feed/effluent heat exchanger 12 for preheating the liquid ammonia into liquid ammonia stream 5 utilizing further cooled effluent gas stream 19 from a fire heated reactor 24, which in this scheme is a specific embodiment of the ammonia cracking reactor. The preheated stream 5 is subjected to evaporation in ammonia evaporator 14 using cooled effluent gas stream 17 from the fire heated reactor 24 as heating medium. A water purge, not shown, may also be provided in connection with the evaporator 14 for removing any water contained in the liquid ammonia stream 5. The resulting ammonia feed stream 7, now in gaseous form, is further preheated to ammonia feed gas stream 9 in first feed/effluent heat exchanger 16 using effluent gas stream 15, i.e. outlet stream 15, from the fire heated reactor 24.

The ammonia feed gas stream 9 is then further preheated in heat exchanging unit 18′e.g. a heating coil, arranged within the convection section 24″′ of the fire heated reactor 24. The thus preheated ammonia feed gas stream 9′ passes to a first and second adiabatic pre-cracking reactors 20, 22, with inter-stage heating of outlet stream 11 in heat exchange unit 18″ to form preheated ammonia feed gas stream 11′. The adiabatic pre-cracking reactors comprise a fixed bed of catalyst, for instance an ammonia synthesis catalyst, such as a Fe-based catalyst, as is known in the art of ammonia synthesis. From the second adiabatic reactor 22, a partly converted ammonia feed stream 13 comprising ammonia, hydrogen and nitrogen; is withdrawn and further preheated in heat exchange unit 18″ to form a preheated partly converted ammonia feed stream 13′ which is then passed to fire heated reactor 24. The fire heated reactor 24 has arranged therein a number of catalyst filled tubes 24′ as well as burners 24″, as schematically shown in the figure. The catalyst is for instance also Fe-based catalyst. The fire heated reactor 24 also comprises a convection zone 24″′, which have arranged therein a number of the heat exchange units 18, 18′, 18″′and 18^{iv}. In the fire heated reactor 24, further dissociation of ammonia takes place, thereby producing the effluent gas stream 15 comprising hydrogen and nitrogen and optionally also unconverted ammonia. The adiabatic reactors 20, 22 and fire heated ammonia cracking reactor 24 combine to avoid having waste heat for steam production.

The effluent gas stream 15 from the fire heated reactor 24 provides heat for feed/effluent heat exchangers 16 and 12, as well as heat for driving the ammonia evaporator 14. The further cooled effluent gas stream 19 is thus cooled in second feed/effluent heat exchanger 12 to form cooled effluent gas stream 21. A water cooler 26 may be provided to additionally cool the effluent gas stream into stream 23 prior to passing it to hydrogen recovery unit 28, which for instance is a PSA unit. The process (method) comprises thereby the cooling of the effluent gas stream 15 by heat exchange with the ammonia feed stream 3, 5, 7 prior to passing the effluent gas stream 15 to the hydrogen recovery unit 28. From the hydrogen recovering unit e.g. PSA unit 28 a hydrogen product stream 25 is withdrawn, as so is an off-gas stream 27 comprising hydrogen, nitrogen and unconverted ammonia. The off-gas stream 27 is preheated in heat exchange unit 18^{iv} to form preheated off-gas stream 27′ and then split in streams 27″ which are used in the burners 24″ of the fire heated reactor 24. Combustion air stream 29 is preheated in heat exchange unit 18 to form preheated air stream 29′ and is then split and supplied to burners 24″ as depicted in the figure, whereby it is mixed with the off-gas 27″. Thereby the use of an external fuel source, such as natural gas, is significantly reduced or totally eliminated. Advantageously also, a portion of said effluent gas stream is diverted and supplied as at least a portion of a separate fuel stream (not shown), instead of using the external fuel source such as natural gas. The portion of said effluent gas stream may for instance be withdrawn as part of the exit stream from the ammonia cracking reactor, or as part of the cooled effluent gas stream entering the hydrogen recovery unit. Flue gas generated during the burning travels in the convection zone 24″′ delivering heat in above mentioned heat exchanging units 18, 18′, 18′′ and 18^{iv} and sent to stack as flue gas stream 31.

With reference to FIG. 2, an effluent gas stream 121 from an ammonia cracking reactor such as an electrically heated reactor (not shown) provides heat for an ammonia recovery reboiler 120″ of ammonia recovery distillation column (distillation column) 120, thus generating a cooled effluent stream 123 which is used to drive ammonia evaporator 118, thus further cooling into cooled effluent stream 125 which is then used for providing heat to feed/effluent heat exchanger 114 (e.g. a first ammonia feed preheater), thereby generating cooled effluent gas stream 127. The process (method) comprises also thereby the cooling of the effluent gas stream 123 by heat exchange with e.g. evaporator 118 and heat exchanger 114 with the ammonia feed stream 105, 115 prior to passing the effluent gas stream 127 to the hydrogen recovery unit. This cooled effluent gas stream 127 is then passed to an effluent gas separator, e.g. effluent gas scrubbing unit 124, using water 141 as scrubbing medium. The water stream 141 is derived from bottoms stream 137 of distillation column 120 after delivering heat in ammonia recovery heat exchanger 122, thus generating a water stream 137′ which may be condensed in a condensate boiler unit (not shown). Make-up water stream 139 may be added to generate the water stream 141.

From the effluent gas scrubbing unit 124, an overhead stream 143 comprising nitrogen and hydrogen is withdrawn, as so is a bottom liquid stream 129 comprising the unconverted ammonia. At least a portion 147 of the overhead stream 143 is passed to a hydrogen recovery comprising two PSA-units 126 and 126′. The other portion 145 is withdrawn as a nitrogen stream. The bottom liquid stream 129 comprising the unconverted ammonia, having and ammonia content of e.g. about 15 mole %, with the rest being predominantly water, is then preheated in heat exchanger 122 using the bottoms stream 137 of the distillation column 120, which is predominantly water e.g. about 90 mole % water and 10 mole % NH₃, as heat exchanging medium, and then fed as stream 129′ into said distillation column 120.

From distillation column 120 an overhead stream 131 is withdrawn, cooled in a second ammonia feed preheater and optionally also an ammonia recovery air cooler (not shown), and passed to ammonia recovery separator 120′ thereby generating a light gas overhead stream 133 comprising hydrogen, nitrogen and ammonia and a reflux stream 135 to the distillation column which is ammonia rich i.e. having 99 mole % or more ammonia, and from which a portion 135′ is withdrawn. Hence, from the overhead stream 131, an ammonia rich stream 135′ is derived and combined with the liquid ammonia 111 imported from storage, and which suitably has been preheated in first ammonia feed preheater 114 described above and subjected to electrolysis in electrolysis unit 112.

Due to transport requirements, traded liquid ammonia normally contains some water, even when it is called anhydrous. For instance, the liquid ammonia 101, 103 being pumped from storage 110 may have a water content of about 0.2 mole %. While this water may be withdrawn as a water purge stream in the ammonia evaporator 118, water removal is suitably provided, such as electrolysis or distillation, as described below.

Therefore, more specifically, water removal is for instance conducted by subjecting the liquid ammonia 101, 103 imported from storage 110, to electrolysis in an alkaline/PEM electrolysis unit 112, thereby generating ammonia feed stream 105, as well as an oxygen product 107 and a hydrogen product 109. Electrolysis upstream the ammonia evaporator, in particular electrolysis of the liquid ammonia imported from storage, e.g. in an alkaline/PEM electrolysis, is preferred where electricity is readily available, particularly when available from green sources such as instances where power is generated from solar or wind sources. At least a portion of the hydrogen product 109 from the electrolysis 112 may be combined with the ammonia feed stream in the at least one ammonia pre-cracking reactor. The portion of the hydrogen product 109 from the electrolysis 112 which is not combined with the ammonia feed gas, is suitably incorporated into the hydrogen product, for instance by mixing with the hydrogen product 149, 149′ from the hydrogen recovery.

Water removal may also be conducted by subjecting the ammonia feed gas stream, as shown by stipple line stream 117′ from the evaporation in evaporator 118 to distillation in said distillation column 120, thereby generating ammonia feed stream 119 which is withdrawn as part of the overhead stream of the distillation column 120 and is water-free. By water-free is meant that the content of water is so low that the catalyst used in the ammonia pre-cracking and/or subsequent ammonia cracking is not affected.

The hydrogen recovery unit comprises at least one Pressure Swing Adsorption (PSA) unit, here shown as PSA-units 126, 126′ for thereby producing hydrogen product 149, 149′ and off-gas stream 151. The hydrogen product in line 149′ is suitably withdrawn as a separate hydrogen stream at higher pressure than in line 149. For instance, the first PSA unit 126 may be operated at about 100 barg thereby producing hydrogen product 149′ at this pressure, while the second PSA unit 126′ is operated at a lower and more typical pressure of about 30 barg thereby producing hydrogen product 149 at this pressure. From the PSA unit 126′, the off-gas stream 151 is withdrawn. This off-gas stream 151 contains for instance about 8% vol. H₂, 91% vol. N₂, less than 1% vol. H₂O and some traces of NH₃ and thus it is of less value as fuel compared to when operating with one PSA-unit, as in FIG. 1.

Now with reference to FIG. 3, a similar layout as in FIG. 2 is shown, with the main differences being that light overhead gas stream 233 from the distillation column 220 is supplied to the effluent gas separator 224 and that heat exchanger 220″′ is used as ammonia feed preheater as part of the reflux system of the distillation column. The small light overhead gas stream 233 from the reflux system of the distillation column 220, primarily consisting of hydrogen and ammonia, secondly of nitrogen, is reused by sending it to the effluent gas separator, e.g. effluent gas scrubbing unit 224. Thereby, valuable hydrogen is subsequently provided via overhead stream 243 comprising nitrogen and hydrogen to the hydrogen recovery unit 226, thus increasing the efficiency of the process (method) and plant (system). The cold liquid ammonia feed stream 201, 203 from storage 210 is advantageously used to condense overhead gas stream 231 from the distillation column 220 in the reflux system, thereby saving the need to resorting to other cooling methods and attendant apparatuses, such as water cooling or air cooling, and preheating the ammonia feed stream itself.

Further, in FIG. 3 effluent gas stream 221 from an ammonia cracking reactor such as an electrically heated reactor (not shown) or a fired heater reactor, for instance either embodiment having no prior ammonia pre-cracking, provides heat for an ammonia recovery reboiler 220″ of ammonia recovery distillation column (distillation column) 220, thus generating a cooled effluent stream 223 which is used to drive ammonia evaporator 218, thus further cooling into cooled effluent stream 225 and subsequently via water cooler 228 into cooled effluent gas stream 227. The ammonia evaporator 218 is fed with preheated ammonia feed stream 205 from ammonia feed pre-heater 220″′. The cooled effluent gas stream 227 is then passed to the effluent gas separator, e.g. effluent gas scrubbing unit 224, using i.a. water as scrubbing medium. A stream 237″ is derived from bottoms stream 237 of distillation column 220, is optionally add-mixed with a make-up water stream (not shown) and delivers heat in ammonia recovery heat exchanger 222, thus generating a water stream 237′ and suitably also after being cooled in water cooler 230 thus generating the water stream 237″. The light overhead gas stream 233 from the reflux system of the distillation column 220 is also fed to the effluent gas scrubbing unit 224.

From the effluent gas scrubbing unit 224, the overhead stream 243 comprising nitrogen and hydrogen is withdrawn, as so is a bottom liquid stream 229 comprising the unconverted ammonia. The overhead stream 243 is passed to a hydrogen recovery comprising two PSA-units 226 and 226′. The bottom liquid stream 229 from the effluent gas scrubbing unit 224 and which comprises the unconverted ammonia is then preheated in heat exchanger 222 using the bottoms stream 237 of the distillation column 220 as heat exchanging medium, as explained above, and then fed as stream 229″ into said distillation column 220. A portion 229′ of the bottom liquid stream 229 is optionally diverted and combined with liquid blowdown (purge stream) 253 from the ammonia evaporator 218.

From distillation column 220 an overhead stream 219, 231 is withdrawn. The water-free ammonia stream 219 (having e.g. 1 ppmv or less H₂O) serves as the ammonia feed stream for pre-cracking and/or the ammonia cracking reactor. The overhead gas stream 231 is cooled in ammonia feed preheater 220″′ and optionally also in a water cooler 220^{iv} arranged in parallel, thus via bypass 231′. The thus condensed overhead gas is passed to ammonia recovery separator 220′ thereby generating the light gas overhead stream 233 and a reflux stream 235 to the distillation column 220. From ammonia liquid storage 210 the ammonia feed stream 201 is pumped as stream 203 to said ammonia feed pre-heater 220″′.

As in connection with FIG. 1, the hydrogen recovery unit comprises here also at least one Pressure Swing Adsorption (PSA) unit, here shown as PSA-units 226, 226′ for thereby producing hydrogen product 249, 249′ and off-gas stream 251

Heat integration for an ammonia cracking process and plant where ammonia is the major or only energy source is thereby achieved so that all important waste heat can be used for preheating/evaporation and subsequent preheating, e.g. superheating, of ammonia when a plurality of ammonia pre-cracking reactors, preferably adiabatic ammonia pre-cracking reactors, for instance two adiabatic ammonia cracking reactors, are used. There is no available waste heat for production of steam, which may be considered as being of low value or of no use. Off-gas from the hydrogen recovery unit, i.e. from hydrogen purification, is optionally used as fuel in an ammonia cracking reactor when e.g. utilizing a fire heated reactor, or the off-gas is used as fuel in a dedicated (separate) fired heater when utilizing an ammonia cracking reactor powered by electricity, such as an electrically heated reactor, thereby further improving the energy efficiency of the process and plant. The provision of ammonia pre-cracking may also be obviated, for instance where the ammonia cracking reactor is electrically heated.

This scheme, as illustrated in FIG. 1-3, having ammonia as the major or only energy source is important in the green transition using ammonia as an energy carrier.

### EMBODIMENTS (POINTS) OF THE INVENTION

The invention encompasses the following points:
1. Method for producing a hydrogen product from ammonia, comprising the steps of:
   i) providing an ammonia feed stream;
   ii) passing the ammonia feed stream to at least one ammonia pre-cracking reactor for producing a partly converted ammonia feed stream comprising ammonia, hydrogen and nitrogen;
   iii) passing the partly converted ammonia feed stream to an ammonia cracking reactor for producing an effluent gas stream comprising hydrogen and nitrogen and optionally also unconverted ammonia;
   iv) passing the effluent gas stream to a hydrogen recovery unit for producing said hydrogen product and an off-gas stream comprising hydrogen, nitrogen and optionally unconverted ammonia,
   wherein step iv) comprises the cooling of the effluent gas stream by heat exchange with the ammonia feed stream prior to passing the effluent gas stream to the hydrogen recovery unit.
2. Method according to point 1, wherein the at least one ammonia pre-cracking reactor is an adiabatic ammonia pre-cracking reactor comprising a catalytic fixed bed and having a decrease in temperature from the inlet to the outlet of the reactor, e.g. of 50-200° C.
3. Method according to any of points 1-2, wherein the ammonia cracking reactor is: a fire heated reactor comprising one or more catalyst-filled tubes, a convection heated reactor, an electrically heated reactor, an induction heated reactor, or combinations thereof.
4. Method according to any of points 1-3, wherein the at least one ammonia pre-cracking reactor and/or the ammonia cracking reactor operate in the temperature range 300-700° C. and with an ammonia synthesis catalyst, such as any of: Fe, Co, Ru or Ni based catalyst, preferably a Fe-based catalyst.
5. Method according to any of points 2-4, wherein step ii) comprises preheating the ammonia feed stream prior to passing the ammonia feed stream to the at least one adiabatic ammonia pre-cracking reactor, preferably by passing the ammonia feed stream to a plurality of pre-cracking reactors, for instance two adiabatic pre-cracking reactors.
6. Method according to any of points 1-5, further comprising:
   v)—passing the off-gas stream to the fire heated reactor or convection heated reactor upon mixing it with an air stream, optionally also with a separate fuel stream, for generating heat required in the fire heated reactor or convection heated reactor; or
   passing the off-gas stream to a fired heater upon mixing it with an air stream, optionally also with a separate fuel stream, for preheating the ammonia feed gas stream, preferably where said ammonia cracking reactor is an electrically heated reactor or an induction heated reactor.
7. Method according to point 6, comprising:
   diverting a portion of said effluent gas stream and supplying it as at least a portion of said separate fuel stream; suitably wherein the portion of said effluent gas stream is withdrawn as part of the produced effluent gas stream from the ammonia cracking reactor, or as part of the cooled effluent gas stream entering the hydrogen recovery unit; and/or
   diverting a portion of an ammonia stream, such as a portion of the ammonia feed stream, and supplying it as at least a portion of said separate fuel stream.
8. Method according to any of points 1-7, wherein step iii) further comprises generating a hot flue gas stream and recovering heat thereof by at least one of:
   said preheating of the ammonia feed stream prior to passing the ammonia feed stream to the at least one adiabatic ammonia pre-cracking reactor;
   preheating of the partly converted ammonia feed stream;
   preheating of the off-gas stream; or
   preheating of the air stream.
9. Method according to any of points 1-8, wherein the ammonia feed stream is derived from liquid ammonia such as liquid ammonia imported from storage, and which has been subjected to: optional water removal, evaporation, and optional pre-heating prior to said evaporation.
10. Method according to point 9, wherein said water removal is conducted by subjecting the liquid ammonia imported from storage to electrolysis in an alkaline or polymer electrolyte membrane (PEM) electrolysis unit, thereby generating said ammonia feed stream, as well as an oxygen product and a hydrogen product.
11. Method according to point 10, wherein at least a portion of the hydrogen product from electrolysis is combined with the ammonia feed stream in the at least one ammonia pre-cracking reactor; or wherein at least a portion of the hydrogen product from electrolysis is supplied as said separate fuel stream.
12. Method according to any of points 1-11, wherein step iv) further comprises recovering unconverted ammonia in the effluent gas stream by distillation in an ammonia recovery distillation column after said cooling of the effluent gas stream by heat exchange with the ammonia feed stream, and wherein after said cooling and prior to the distillation, the thus cooled effluent gas stream is supplied to an effluent gas separator, such as an effluent gas scrubbing unit using water as scrubbing medium, for generating an overhead stream comprising nitrogen and hydrogen, and a bottom liquid stream comprising the unconverted ammonia.
13. Method according to any of points 9-12, wherein said water removal is conducted by subjecting the ammonia feed gas stream from the evaporation step to distillation in said ammonia recovery distillation column, thereby generating said ammonia feed stream.
14. Method according to points 9 and 12-13, wherein said pre-heating prior to evaporation of the ammonia feed stream which is derived from liquid ammonia such as liquid ammonia imported from storage, comprises heat exchanging with an overhead gas stream withdrawn from the ammonia recovery distillation column.
15. Method according to any of points 12-14, wherein a light overhead gas stream comprising hydrogen and ammonia is withdrawn from the ammonia recovery distillation column, suitably from said overhead gas stream, and supplied to said effluent gas separator.
16. Method according to any of points 1-15, wherein the hydrogen recovery unit comprises at least one Pressure Swing Adsorption (PSA) unit for thereby producing said hydrogen product and said off-gas stream.
17. Method according to point 16, wherein:
   the hydrogen recovery unit comprises a first and second PSA unit for producing said hydrogen product, the method further comprising withdrawing and compressing a first off-gas stream from the first PSA unit and passing it to the second PSA unit for thereby producing said off-gas stream; or
   the hydrogen recovery unit comprises a membrane unit and a PSA unit.
18. Method for producing a hydrogen product from ammonia, comprising the steps of:
   providing an ammonia feed stream;
   passing the ammonia feed stream to an ammonia cracking reactor for producing an effluent gas stream comprising hydrogen and nitrogen and optionally also unconverted ammonia;
   passing the effluent gas stream to a hydrogen recovery unit for producing said hydrogen product and an off-gas stream comprising hydrogen, nitrogen and optionally unconverted ammonia; the step further comprising the cooling of the effluent gas stream by heat exchange with the ammonia feed stream prior to passing the effluent gas stream to the hydrogen recovery unit;
   and wherein prior to said step of passing the ammonia feed stream to the ammonia cracking reactor, the method is absent of a step of passing the ammonia feed stream to an ammonia pre-cracking reactor for producing a partly converted ammonia feed stream comprising ammonia, hydrogen and nitrogen.
19. System for producing a hydrogen product from ammonia, comprising:
   at least one pre-cracking reactor, such as an adiabatic pre-cracking reactor, arranged to receive an ammonia feed stream, said at least one pre-cracking reactor preferably having arranged therein a catalytic fixed-bed for producing a partly converted ammonia feed stream comprising ammonia, hydrogen and nitrogen;
   an ammonia cracking reactor arranged to receive the partly converted ammonia feed stream for producing an effluent gas stream comprising hydrogen and nitrogen and optionally also unconverted ammonia;
   a hydrogen recovery unit, arranged to receive the effluent gas stream for producing the hydrogen product and an off-gas stream comprising hydrogen, nitrogen and optionally unconverted ammonia;
   wherein the system further comprises at least one heat exchanger adapted upstream the hydrogen recovery unit for cooling said effluent gas stream by heat exchange with the ammonia feed stream.
20. System for producing a hydrogen product from ammonia, comprising:
   an ammonia cracking reactor arranged to receive an ammonia feed stream for producing an effluent gas stream comprising hydrogen and nitrogen and optionally also unconverted ammonia;
   a hydrogen recovery unit, arranged to receive the effluent gas stream for producing the hydrogen product and an off-gas stream comprising hydrogen, nitrogen and optionally unconverted ammonia;
   wherein the system further comprises at least one heat exchanger adapted upstream the hydrogen recovery unit for cooling said effluent gas stream by heat exchange with the ammonia feed stream;
   and wherein the system is absent of a pre-cracking reactor upstream said ammonia cracking reactor.

1. Method for producing a hydrogen product from ammonia, comprising the steps of:
i) providing an ammonia feed stream;
ii) passing the ammonia feed stream to at least one ammonia pre-cracking reactor for producing a partly converted ammonia feed stream comprising ammonia, hydrogen and nitrogen;
iii) passing the partly converted ammonia feed stream to an ammonia cracking reactor for producing an effluent gas stream comprising hydrogen and nitrogen and optionally also unconverted ammonia;
iv) passing the effluent gas stream to a hydrogen recovery unit for producing said hydrogen product and an off-gas stream comprising hydrogen, nitrogen and optionally unconverted ammonia,
wherein step iv) comprises the cooling of the effluent gas stream by heat exchange with the ammonia feed stream prior to passing the effluent gas stream to the hydrogen recovery unit.

2. The method according to claim 1, wherein the ammonia cracking reactor is: a fire heated reactor comprising one or more catalyst-filled tubes, a convection heated reactor, an electrically heated reactor, an induction heated reactor, or combinations thereof.

3. The method according to claim 1, wherein the at least one ammonia pre-cracking reactor and/or the ammonia cracking reactor operate in the temperature range 300-700° C. and with an ammonia synthesis catalyst.

4. The method according to claim 1, further comprising:
v)—passing the off-gas stream to the fire heated reactor or convection heated reactor upon mixing it with an air stream, optionally also with a separate fuel stream, for generating heat required in the fire heated reactor or convection heated reactor; or
passing the off-gas stream to a fired heater upon mixing it with an air stream.

5. The method according to claim 4, comprising:
diverting a portion of said effluent gas stream and supplying it as at least a portion of said separate fuel stream; and/or
diverting a portion of an ammonia stream and supplying it as at least a portion of said separate fuel stream.

6. The method according to claim 1, wherein the ammonia feed stream is derived from liquid ammonia and which has been subjected to: optional water removal, evaporation, and optional pre-heating prior to said evaporation.

7. The method according to claim 6, wherein said water removal is conducted by subjecting the liquid ammonia imported from storage to electrolysis in an alkaline or polymer electrolyte membrane (PEM) electrolysis unit, thereby generating said ammonia feed stream, as well as an oxygen product and a hydrogen product.

8. The method according to claim 1, wherein step iv) further comprises recovering unconverted ammonia in the effluent gas stream by distillation in an ammonia recovery distillation column after said cooling of the effluent gas stream by heat exchange with the ammonia feed stream, and wherein after said cooling and prior to the distillation, the thus cooled effluent gas stream is supplied to an effluent gas separator, for generating an overhead stream comprising nitrogen and hydrogen, and a bottom liquid stream comprising the unconverted ammonia.

9. The method according to claim 6, wherein said water removal is conducted by subjecting the ammonia feed gas stream from the evaporation step to distillation in said ammonia recovery distillation column, thereby generating said ammonia feed stream.

10. The method according to claim 6, wherein said pre-heating prior to evaporation of the ammonia feed stream which is derived from liquid ammonia, comprises heat exchanging with an overhead gas stream withdrawn from the ammonia recovery distillation column.

11. The method according to claim 8, wherein a light overhead gas stream comprising hydrogen and ammonia is withdrawn from the ammonia recovery distillation column, suitably from said overhead gas stream, and supplied to said effluent gas separator.

12. The method according to claim 1, wherein the hydrogen recovery unit comprises at least one Pressure Swing Adsorption (PSA) unit for thereby producing said hydrogen product and said off-gas stream.

13. The method according to claim 12, wherein:
the hydrogen recovery unit comprises a first and second PSA unit for producing said hydrogen product, the method further comprising withdrawing and compressing a first off-gas stream from the first PSA unit and passing it to the second PSA unit for thereby producing said off-gas stream; or.
the hydrogen recovery unit comprises a membrane unit and a PSA unit.

14. Method for producing a hydrogen product from ammonia, comprising the steps of:
providing an ammonia feed stream;
passing the ammonia feed stream to an ammonia cracking reactor for producing an effluent gas stream comprising hydrogen and nitrogen and optionally also unconverted ammonia;
passing the effluent gas stream to a hydrogen recovery unit for producing said hydrogen product and an off-gas stream comprising hydrogen, nitrogen and optionally unconverted ammonia; the step further comprising the cooling of the effluent gas stream by heat exchange with the ammonia feed stream prior to passing the effluent gas stream to the hydrogen recovery unit; and
wherein prior to said step of passing the ammonia feed stream to the ammonia cracking reactor, the method is absent of a step of passing the ammonia feed stream to an ammonia pre-cracking reactor for producing a partly converted ammonia feed stream comprising ammonia, hydrogen and nitrogen.

15. System for producing a hydrogen product from ammonia, comprising:
at least one pre-cracking reactor, arranged to receive an ammonia feed stream;
an ammonia cracking reactor arranged to receive the partly converted ammonia feed stream for producing an effluent gas stream comprising hydrogen and nitrogen and optionally also unconverted ammonia;
a hydrogen recovery unit, arranged to receive the effluent gas stream for producing the hydrogen product and an off-gas stream comprising hydrogen, nitrogen and optionally unconverted ammonia;
wherein the system further comprises at least one heat exchanger adapted upstream the hydrogen recovery unit for cooling said effluent gas stream by heat exchange with the ammonia feed stream.

16. System for producing a hydrogen product from ammonia, comprising:
an ammonia cracking reactor arranged to receive an ammonia feed stream for producing an effluent gas stream comprising hydrogen and nitrogen and optionally also unconverted ammonia;
a hydrogen recovery unit, arranged to receive the effluent gas stream for producing the hydrogen product and an off-gas stream comprising hydrogen, nitrogen and optionally unconverted ammonia;
wherein the system further comprises at least one heat exchanger adapted upstream the hydrogen recovery unit for cooling said effluent gas stream by heat exchange with the ammonia feed stream; and
wherein the system is absent of a pre-cracking reactor upstream said ammonia cracking reactor.
